(19) United States
(12) Patent Application Publication
(10) Pub. No.: US 2008/0049570 A1
(43) Pub. Date: Feb. 28, 2008

(54) MINIMUM DEFLECTION ACCELERATION POINT DETECTION, FOCUS PULL-IN, AND LAYER JUMP METHODS, AND OPTIONAL DISC DRIVE CAPABLE OF PERFORMING THE METHODS

(75) Inventors: Young-Jae Park, Yongin-si (KR); Kab-kyun Jeong, Yongin-si (KR); Jong-hyun Shin, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/681,414

(22) Filed: Mar. 2, 2007

(30) Foreign Application Priority Data
Aug. 25, 2006 (KR) 2006-81174

(51) Int. Cl. G11B 7/0037

(52) U.S. Cl. 369/44.28; 369/44.11; 369/44.27

(57) ABSTRACT

Minimum deflection acceleration point detection, focus pull-in, and layer jump methods, and an optical disc drive capable of performing the methods. The method of detecting a minimum deflection acceleration point in an optical disc drive includes rotating a disc loaded in the optical disc drive, detecting a first minimum deflection acceleration point of the disc during one rotation cycle of the disc, and detecting a second minimum deflection acceleration point of the disc during one rotation cycle of the disc. Thus, a stable focus pull-in and layer jump is available.

### CROSS-REFERENCE TO RELATED APPLICATION

This application claims all the benefits accruing under 35 U.S.C. §119 from Korean Patent Application No. 2006-81174 filed on Aug. 25, 2006, in the Korean Intellectual Property Office, the disclosure of which is incorporated herein by reference.

### BACKGROUND OF THE INVENTION

1. Field of the Invention

Aspects of the present invention relate to an optical disc drive, and, more particularly, to minimum deflection acceleration point detection, focus pull-in, and layer jump methods, and an optical disc drive capable of performing the methods.

2. Related Art

An optical disc drive is an optical information storing and reproducing apparatus. The optical disc drive performs focus pull-in operations with respect to a data layer (or a recording layer) of an optical disc by moving an objective lens of an actuator in a direction perpendicular to the data layer of the loaded disc. The focus pull-in operation forms a focal point of an optical spot on the data layer of the disc and is referred to as focusing.

The focus pull-in operation may be performed after a static detect disc type (DDT) process is performed. FIG. 1 is an operation timing diagram to explain the process of performing an upward focus pull-in operation after the conventional static DDT process is performed in an optical disc drive. The static DDT process determines the type of a disc when the disc is not rotating. As shown in FIG. 1, main operations 0 through 3 are the static DDT process. That is, in operation 0, a laser diode, which is provided in the optical disc drive, is turned on and the object lens is moved downward to a lowest point 101 where the reflection of a surface layer of the disc is detectable. In operations 1 and 2, the objective lens is moved up and down to determine the type of the disc using a reflectance and an interlayer distance (T1: the disc thickness between the surface layer and the data layer when the objective lens is moved up; and T2: the disc thickness between the data layer and the surface layer when the objective lens is moved down).

In operation 3, an effectiveness of the determination of the type of the disc through the static DDT process is verified. Next, in operation 4, the upward focus pull-in process is performed using an s-curve detection condition (the absolute value of a level of a focus error signal (FES)>L1) of the data layer according to the disc type. Also, in operation 4, the upward focus pull-in is performed at a point t10 that satisfies the s-curve detection condition of the data layer. In operation 10, a focusing servo operation is performed. Thus, the focusing servo operation in operation 10 is performed when the disc is rotated and an optical spot is focused on the data layer of the disc.

FIG. 2 is an operation timing diagram to explain the process of performing a downward focus pull-in operation after the conventional static DDT process is performed in an optical disc drive. The static DDT process performed between operations 0 through 3 is the same as that shown in FIG. 1. However, FIG. 2 is an operation timing diagram to explain a downward focus pull-in process. Thus, in operation 5, the downward focus pull-in is performed at a point t10 where the data layer, which satisfies the focus pull-in condition (FES level absolute value>L1), is detected while the objective lens is moved downward. In operation 10, the focusing servo operation is performed.

In FIG. 1 and FIG. 2, “S0” refers to a position at which a surface layer s-curve is detected when the objective lens is moved upward from the lowest point 101. “S1” refers to a position at which a data layer s-curve is detected when the objective lens is moved upward from the surface layer to the data layer of the disc. “S2” refers to a position at which the data layer s-curve is detected when the objective lens is moved downward from the highest point 102. Lastly, “S3” refers to a position at which the surface layer s-curve is detected when the objective lens is moved downward from the data layer to the surface layer of the disc.

In FIG. 1 and FIG. 2, “L0” refers to a focus error signal level to be recognized as the data layer s-curve in the static DDT process, which can be set to be about 50% of a data layer FES peak level. “L1” refers to a focus error signal level to be recognized as the data layer s-curve in the focus pull-in process, which can be set to be about 50% of the data layer FES peak level. “L2” refers to a focus error signal level to turn on a focus servo controller provided in the optical disc drive when the data layer s-curve “L1” is recognized in the focus pull-in process and FES level is returned to a reference level (0V), which can be set to be about 25% of the data layer FES peak level, “L3” refers to a radio frequency direct current (RFDC) error signal level to recognize the data layer in the static DDT process and the focus pull-in process, which can be set to be about 50% of a data layer RFDC peak level. Lastly, “L4” refers to an RFDC error signal level to recognize the surface layer in the static DDT process and the focus pull-in process, which can be set to be about 50% of a surface layer RFDC peak level. The values of “L1”, “L2”, “L3”, and “L4” are set according to the disc type determined in the static DDT process.

In FIG. 1 and FIG. 2, “T1” refers to an upward movement time from t2 when the RFDC signal level is greater than L4, to t3 when the RFDC signal level is greater than L3, in the DDT upward movement process. “T2” refers to a downward movement time from t5 when the RFDC signal level in the data layer S2 is less than L3, to t6 when the RFDC signal level is less than L4 in the DDT downward movement process. “T3” refers to a DDT process result verification or spindle acceleration time. “T4” refers to a time corresponding to the disc thickness between the surface layer and the data layer in the focus pull-in process. Lastly, “T5” refers to a time for a single turn of a spindle.

Referring to FIG. 1 and FIG. 2, it can be seen that the focus pull-in is performed while the spindle is rotated. However, when the spindle is rotated, a disc deflection component repeatedly appears for every single rotation. Thus, when the focus pull-in is performed at a point having an arbitrary deflection acceleration of a disc having a high deflection, it is highly likely that the focus pull-in will fail and that the disc will collide against the objective lens. Also, when a layer jump is performed at a point having an arbitrary deflection acceleration of a disc having a high deflection, it is highly likely that the layer jump will fail and that the disc will collide against the objective lens.

### SUMMARY OF THE INVENTION

To solve the above and/or other problems, the present invention provides a method of detecting a minimum deflection acceleration point in an optical disc drive, and an optical disc drive capable of performing the method.

Aspects of the present invention also provide a focus pull-in method to perform focus pull-in at the minimum deflection acceleration point, and an optical disc drive capable of performing the method.

Aspects of the present invention also provide a layer jump method to perform a layer jump at the minimum deflection acceleration point, and an optical disc drive capable of performing the method.

According to an aspect of the present invention, a method of detecting a minimum deflection acceleration point in an optical disc drive comprises rotating a disc loaded in the optical disc drive, detecting a first minimum deflection acceleration point of the disc during one rotation cycle of the disc, and detecting a second minimum deflection acceleration point of the disc during one rotation cycle of the disc.

According to another aspect of the present invention, a focus pull-in method in an optical disc drive comprises calculating an amount of change of a focus actuator drive signal when a one rotation start of a disc loaded in the optical disc drive is notified, generating a focus actuator drive signal according to the amount of change of the focus actuator drive signal when a first minimum deflection acceleration point is detected after the one rotation start of the disc, and performing focus pull-in with respect to the disc when a point satisfying a focus pull-in condition is detected.

According to another aspect of the present invention, a layer jump method in an optical disc drive comprises turning off a focus servo control portion of the optical disc drive when a first minimum deflection acceleration point is detected after a layer jump is required, generating a focus actuator drive signal to or from which a kick pulse is added or subtracted according to a layer jump direction, and generating a focus actuator drive signal to or from which a brake pulse is added or subtracted according to a layer jump direction when a level of a focus error signal satisfies a layer jump condition.

According to another aspect of the present invention, an optical disc drive comprises a disc loaded in the optical disc drive, a rotation unit rotating the disc and a servo digital signal processor detecting a first minimum deflection acceleration point and a second minimum deflection acceleration point during one rotation cycle of the disc.

When the one rotation start of the disc is recognized based on a frequency generation signal provided by the rotation unit, the servo digital signal processor calculates an amount of change of a focus actuator drive signal, generates a focus actuator drive signal according to the amount of change of the focus actuator drive signal when the first minimum deflection acceleration point is detected after the one rotation start, and controls focus pull-in with respect to the disc when a point satisfying a focus pull-in condition is detected.

When the layer jump is required, the servo digital signal processor turns off a focus servo control operation when the first minimum deflection acceleration point is detected after the layer jump is required, generates a focus actuator drive signal to or from which a kick pulse is added or subtracted according to a layer jump direction, and generates a focus actuator drive signal to or from which a brake pulse is added or subtracted according to a layer jump direction when a level of a focus error signal satisfies a layer jump condition.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is an operation timing diagram for explaining the process of performing an upward focus pull-in after the conventional static DDT process is performed in an optical disc drive;

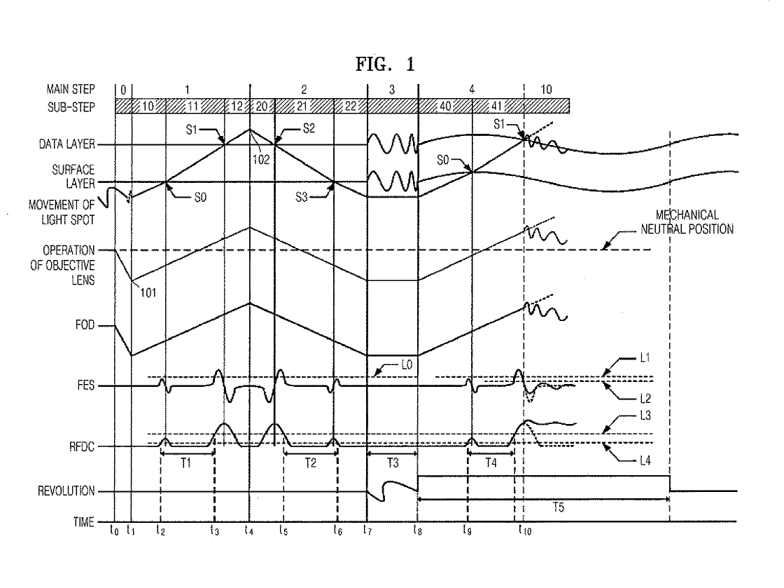

FIG. 2 is an operation timing diagram for explaining the process of performing a downward focus pull-in after the conventional static DDT process is performed in an optical disc drive;

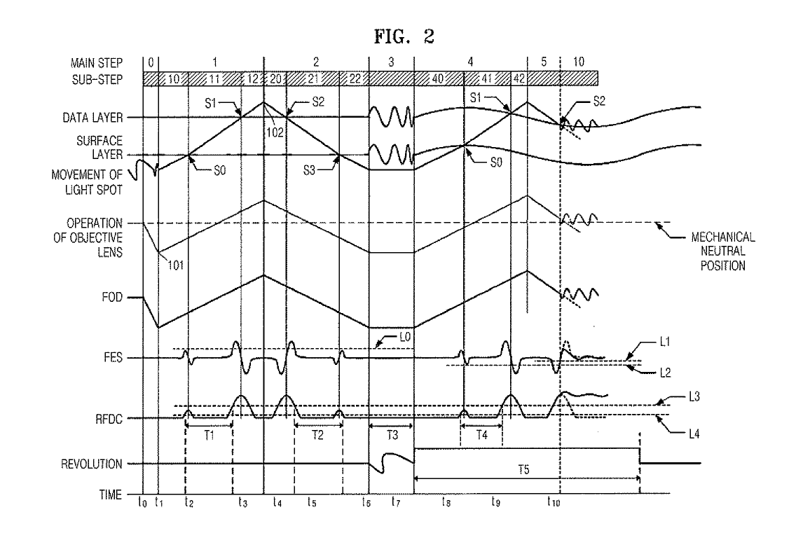

FIG. 3 is a block diagram of an optical disc drive according to an example embodiment of the present invention;

FIG. 4 is an operation timing diagram for explaining the minimum deflection acceleration point detection process in the optical disc drive shown in FIG. 3;

FIG. 5 is a view of the minimum defection acceleration point detection based on FIG. 4;

FIG. 6 is a block diagram of an optical disc drive according to another example embodiment of the present invention;

FIG. 7 is an operation timing diagram of the upward focus pull-in around the minimum deflection acceleration point having the (−) maximum deflection size in the optical disc drive shown in FIG. 6;

FIG. 8 is an operation timing diagram of the upward focus pull-in around the minimum deflection acceleration point having the (+) maximum deflection size in the optical disc drive shown in FIG. 6;

FIG. 9 is an operation timing diagram of the layer jump in the optical disc drive shown in FIG. 6;

FIG. 10 is a flow chart for explaining the minimum deflection acceleration point detection method according to still another example embodiment of the present invention;

FIG. 11 is a detailed flow chart of an example of the minimum deflection acceleration point detection process shown in FIG. 10;

FIG. 12 is a detailed flow chart of another example of the minimum deflection acceleration point detection process shown in FIG. 10;

FIG. 13 is an operation flow chart of the focus pull-in method according to yet another example embodiment of the present invention;

FIG. 14 is a detailed flow chart of the focus pull-in process shown in FIG. 13; and

FIG. 15 is an operation flow chart of a layer jump method according to yet another example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

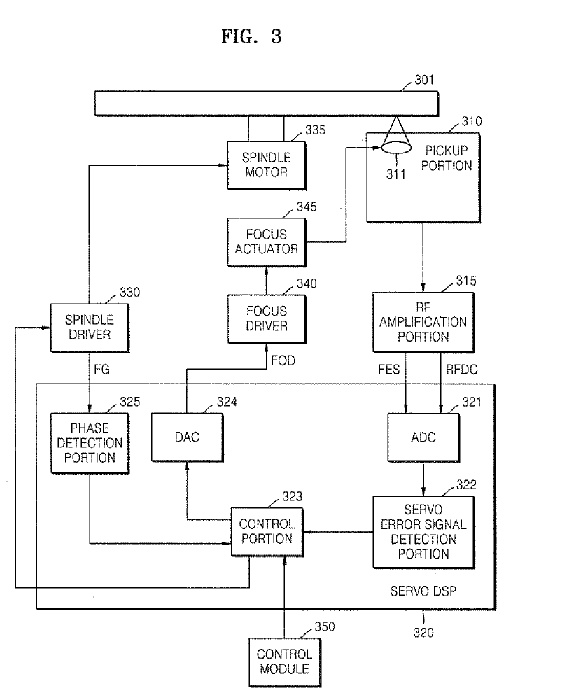

FIG. 3 is a block diagram of an optical disc drive according to an example embodiment of the present invention. For purposes of brevity, such an optical disc drive can be internal (housed within a host) or external (housed in a separate box that connects to a host). In addition, such an optical disc drive can be a single apparatus, or can be separated into a recording apparatus or a reading apparatus. As shown in FIG. 3, an optical disc drive includes a disc 301, a pickup portion 310, an RF amplification portion 315, a servo digital signal processor (hereinafter, referred to as “servo DSP (digital signal processor)”) 320, a spindle driver 330, a spindle motor 335, a focus driver 340, a focus actuator 345, and a control module 350. The disc 310 is a disc that is capable of storing or reproducing optical information and may be a low density disc, such as a CD or DVD. The disc 301 may also be a high density disc 301, such as a Blu-ray disc (BD) and advanced optical disc (AOD).

The pickup portion 310 includes an objective lens 311, which is moved perpendicular to the disc 301 by the focus actuator 345. The pickup portion 310 condenses light reflected from the disc 301 and outputs the condensed light to the RF amplification portion 315. The reflected light may be condensed using, for example, a quadrant PD (photo diode). The RF amplification portion 315 generates and outputs a focus error signal (FES) and an RFDC servo error signal from a signal output from the pickup portion 310. When the respective divisions of the quadrant PD are A, B, C, and D, the RF amplification portion 315 generates the FES using an astigmatism method ((A+C)−(B+D)) with respect to each of the divided light amounts and the RFDC servo error signal using the total sum (A+B+C+D or RF SUM). The servo DSP 320 repeats the up/down or down/up movement of the objective lens 311 several times during the one rotation cycle of the disc 301 to detect the first minimum deflection acceleration point having the (+) maximum deflection size of a data layer of the disc 301 and the second minimum deflection acceleration point having the (−) maximum deflection size of the data layer of the disc 301. The up/down movement of the objective lens 311 involves the objective lens 311 moving upward and then downward. The down/up movement of the objective lens 311 involves the objective lens 311 moving downward and then upward.

For this purpose, the servo DSP 320, as shown in FIG. 3, includes an analog digital converter (ADC) 321, a servo error signal detection portion 322, a control portion 323, a digital analog converter (DAC) 324, and a phase detection portion 325. First, the control portion 323 drives the spindle motor 335 through the spindle driver 330 to cause the disc 301 to rotate. The rotation of the disc 301 can be included in a dynamic detect disc type (DTT) process. The spindle driver 330 provides the servo DSP 320 with a frequency generator (hereinafter, referred to as an “FG”) signal that refers to information on the speed of the spindle motor 335. The phase detection portion 325 of the servo DSP 320 receives the FG signal. The phase detection portion 325 can provide the control portion 323 with a signal indicating the start of one rotation of the disc 301 using the received FG signal.

When a signal indicating the start of one rotation of the disc 301 is received, the control portion 323 outputs an actuator drive signal (FOD) through the DAC 324. The focus driver 340 drives the focus actuator 345 according to a focus actuator drive signal (FOD). Accordingly, the focus actuator 345 moves the objective lens 311 in a vertical direction.

As the objective lens 311 moves in the vertical direction, the RF amplification portion 315 outputs the FES and RFDC. The ADC 321 converts the FES and RFDC output by the RF amplification portion 315 into a digital signal. The digitalized FES and RFDC are input to the servo error signal detection portion 322. The servo error signal detection portion 322 detects the surface layer and data layer of the disc 301 from the input FES and RFDC and transmits a detection result to the control portion 323.

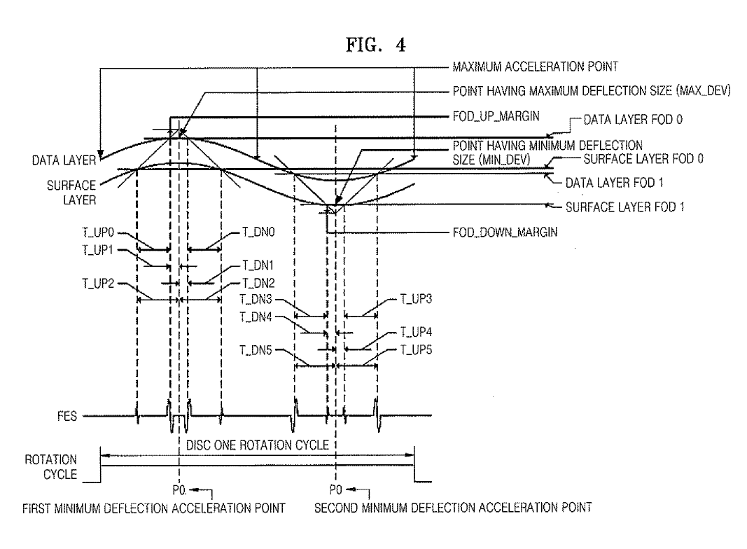

The control portion 323 detects the first and second minimum deflection acceleration points based on the detection result provided by the servo error signal detection portion 322. FIG. 4 is an operation timing diagram to explain the minimum deflection acceleration point detection process in the optical disc drive shown in FIG. 3. As shown in FIG. 4, when the objective lens 311 moves downward after moving upward, the control portion 323 detects the first minimum deflection acceleration point P0 based on the symmetry of the surface layer and the data layer of the disc 301. The first minimum deflection acceleration point P0 can be defined as a point having the (+) maximum deflection size of the data layer of the disc 301.

When the objective lens 311 moves upward and then downward, to determine the symmetry of the surface layer and the data layer of the disc 301, the control portion 323 detects T_UP0 and T_DN0, T_UP1 and T_DN1, or T_UP2 and T_DN2, shown in FIG. 4. According to alternate example embodiments, the control portion 323 may detect all of them or two of them, based on the s-curve detection point information of the FES provided by the servo error signal detection portion 322 and the maximum FOD value (FOD_MAX) during the upward movement of the objective lens 311. The maximum FOD value is updated by focus up margin (FOD_UP_MARGIN) information that is stored previously.

The focus up margin limits the maximum value (FOD_MAX) of the focus actuator drive signal output after the s-curve of the data layer of the disc 301 is detected when the objective lens 311 moves upward. When the focus actuator drive signal reaches the maximum value (FOD_MAX) updated by the focus up margin, the movement direction of the objective lens 311 is changed. “T_UP0” refers to a time from the surface layer detection to the data layer detection of the disc 301 during the upward movement of the objective lens 311. “T_DN0” refers to a time from the data layer detection to the surface layer detection of the disc 301 during the downward movement of the objective lens 311. “T_UP1” refers to a time from the data layer detection of the disc 301 to the movement direction change of the objective lens 311 during the upward movement of the objective lens 311. “T_DN1” refers to a time from the movement direction change of the objective lens 311 to the data layer detection during the downward movement of the objective lens 311. “T_UP2” refers to a time from the surface layer detection of the disc 301 to the movement direction change of the objective lens 311 during the upward movement of the objective lens 311. “T_DN2” refers to a time from the movement direction change of the objective lens 311 to the surface layer detection during the downward movement of the objective lens 311.

Thus, when the objective lens 311 moves upward and then downward, the control portion 323 determines the symmetry of the surface layer and the data layer of the disk 301 at a phase of the disc one rotation cycle using the T_UP0 and T_DN0, the T_UP1 and T_DN1, or the T_UP2 and T_DN2. That is, whether the surface layer or data layer of the disc 301, during the upward movement of the objective lens 311 and the surface layer or data layer of the disc 301 during the downward movement of the objective lens 311, at a phase of the disc one rotation cycle, are symmetric can be determined.

For the determination of the symmetry using the T_UP0 and T_DN0, the T_UP1 and T_DN1, or the T_UP2 and T_DN2, the control portion 323 can use critical values DIFF_UPDOWN0, DIFF_UPDOWN1, and DIFF_UPDOWN2. The predetermined critical values are set in consideration of a predetermined error range. Thus, when the conditions of Equation 1 (see below) are met, the control portion 323 determines that the surface layer or data layer of the disc 301 during the upward movement of the objective lens 311 and the surface layer or data layer of the disc 301 during the downward movement of the objective lens 311 have symmetry at a phase of the disc one rotation cycle when the objective lens 311 moves upward and then downward. When the surface layer or data layer of the disc 301 during the upward movement of the objective lens 311 and the surface layer or data layer of the disc 301 during the downward movement of the objective lens 311 have symmetry, the objective lens 311 and the disc 301 can be determined to be horizontal.

T_UP0−T_{—}DN0<DIFF_UPDOWN0

T_UP1−T_{—}DN1<DIFF_UPDOWN1

T_UP2−T_{—}DN2<DIFF_UPDOWN2 [Equation 1]

The control portion 323 selects at least one of the three (3) conditions defined by Equation 1, and determines whether the objective lens 311 and the disc 301 are oriented horizontally at a phase of the disc one rotation cycle when the objective lens 311 moves upward and then downward. When the objective lens 311 and the disc 301 are determined to be horizontal, the control portion 323 detects a movement direction change point when the objective lens 311 moves upward and then downward as the first minimum deflection acceleration point P0. When the objective lens 311 moves downward and then upward, the control portion 323 determines a phase at which the disc 301 and the objective lens 311 are horizontal based on Equation 2 and detects the second minimum deflection acceleration point P1. That is, whether the surface layer or data layer of the disc 301 during the downward movement of the objective lens 311 and the surface layer or data layer of the disc 301 during the upward movement of the objective lens 311 are symmetrical at the phase of the disk one rotation cycle is determined. When the surface layer or data layer of the disc 301 is determined to be symmetric, which means that the disc 301 and the objective lens 311 are horizontal, the phase at that time is detected as the second minimum deflection acceleration point P1. The second minimum deflection acceleration point P1 can be defined as a point having the (−) maximum deflection size of the data layer of the disc 301.

T_UP3−T_{—}DN3<DIFF_UPDOWN0

T_UP4−T_{—}DN4<DIFF_UPDOWN1

T_UP5−T_{—}DN5<DIFF_UPDOWN2 [Equation 2]

The control portion 323 selects at least one of three (3) conditions defined by Equation 2, and determines whether the surface layer or data layer of the disc 301 during the downward movement of the objective lens 311 and the surface layer or data layer of the disc 301 during the upward movement of the objective lens 311 have symmetry. This allows for a determination of whether the disc 301 and the objective lens 311 are horizontal when the objective lens 311 moves downward and then upward.

In Equation 2, “T_DN3” refers to a time from the data layer detection to the surface layer detection of the disc 301 during the downward movement of the objective lens 311. “T_DN4” refers to a time from the surface layer detection to the movement direction change of the objective lens 311 during the downward movement of the objective lens 311. “T_DN5” refers to a time from the data layer detection to the movement direction change of the objective lens 311 during the downward movement of the objective lens 311. “T_UP3” refers to a time from the surface layer detection to the data layer detection during the upward movement of the objective lens 311. “T_UP4” refers to a time from the movement direction change of the objective lens 311 to the surface layer detection during the upward movement of the objective lens 311. “T_UP5” refers to a time from the movement direction change of the objective lens 311 to the data layer detection during the upward movement of the objective lens 311. The movement direction change point when the objective lens 311 moves downward and then upward is determined by a focus down margin FOD₁₃ DOWN_MARGIN. The focus down margin is a margin to restrict the minimum value FOD_MIN of the focus actuator drive signal that is output after the surface s-curve of the disc 301 is detected during the downward movement of the objective lens 311.

When the surface layer and the data layer of the disc 301 are determined to have symmetry along the movement direction of the objective lens 311 with respect to the phase as a result of the symmetry determination, the control portion 323 detects the movement direction change point when the objective lens 311 moves downward and then upward, as the second minimum deflection acceleration point P0.

Also, the control portion 323 can detect the first minimum deflection acceleration point P0 and the second minimum deflection acceleration point P1 using the symmetry of the focus actuator drive signal FOD output to the DAC 324. That is, the symmetry of the focus actuator drive signal is determined by checking whether the level (surface layer FOD0) of the focus actuator drive signal during the surface layer detection of the disc 301 when the objective lens 311 moves upward and the level (surface layer FOD0) of the focus actuator drive signal during the surface layer detection of the disc 301 when the objective lens 311 moves downward are the same. Also, the symmetry of the focus actuator drive signal is determined by checking whether the level (data layer FOD0) of the focus actuator drive signal during the data layer detection of the disc 301 when the objective lens 311 moves upward and the level (data layer FOD0) of the focus actuator drive signal during the data layer detection of the disc 301 when the objective lens 311 moves downward are the same. As a result of the determination, when the focus actuator drive signal has symmetry, the control portion 323 detects the movement direction change point after the upward movement of the objective lens 311, as the first minimum deflection acceleration point P0.

Further, the symmetry is determined by checking whether the level (surface layer FOD1) of the focus actuator drive signal during the surface layer detection of the disc 301 when the objective lens 311 moves downward and the level (surface layer FOD1) of the focus actuator drive signal during the surface layer detection of the disc 301 when the objective lens 311 moves upward are the same. Also, the symmetry of the focus actuator drive signal is determined by checking whether the level (data layer FOD1) of the focus actuator drive signal during the data layer detection of the disc 301 when the objective lens 311 moves downward and the level (data layer FOD1) of the focus actuator drive signal during the data layer detection of the disc 301 when the objective lens 311 moves upward are the same. As a result of the determination, when the focus actuator drive signal has symmetry, the control portion 323 detects the movement direction change point after the downward movement of the objective lens 311, as the second minimum deflection acceleration point P1.

The control portion 323 can convert the detected first and second minimum deflection acceleration points P0 and P1 to phase values P0′ and P1′ at the one rotation cycle of the disc 301 and can store the same.

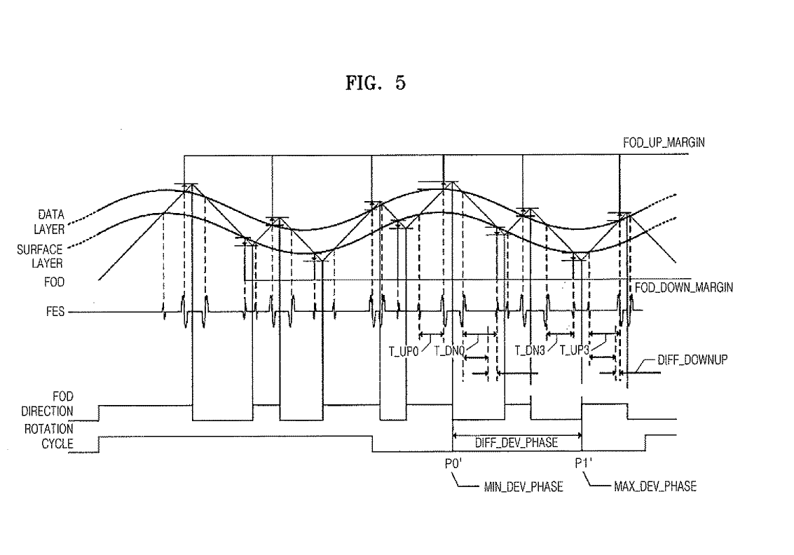

FIG. 5 is a view of the minimum deflection acceleration point detection based on FIG. 4. As shown in FIG. 5, the phase value P0′ of the first minimum deflection acceleration point P0 is detected using the values of T_UP0 and T_DN0 in the minimum deflection acceleration point detection process shown in FIG. 4 and with the T_UP0 and T_DN0 having an error range corresponding to DIFF_UPDOWN. Also, as shown in FIG. 5, the phase value P1′ of the second minimum deflection acceleration point P1 is detected using the T_DN3 and T_UP3 and the T_DN3 and T_UP3 have an error range corresponding to DIFF_UPDOWN. In FIG. 5, the DIFF_DEV_PHASE refers to a phase difference between the phase values P0′ and P1′ that is 180°. The 180° phase difference refers to a time corresponding to ½ of the one rotation cycle of disc 301.

The control module 350 monitors and controls the operation of an optical disc drive shown in FIG. 3. The control module 350 receives a command from a user or a host computer, and monitors and controls the operation of the optical disc drive so that the servo DSP 320 detects the minimum deflection acceleration point as described above.

The spindle driver 330 and the spindle motor 335 can be defined as a rotation unit to rotate the disc 301 loaded in the optical disc drive. The focus driver 340 and the focus actuator 345 move the objective lens 311 in the vertical direction according to the focus actuator drive signal FOD output from the servo DSP 320.

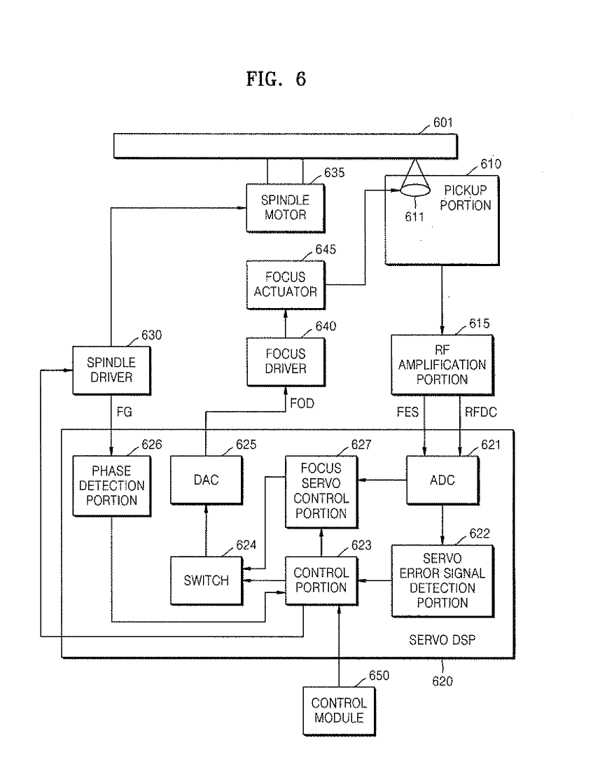

Turning now to FIG. 6, a block diagram of an optical disc drive according to another embodiment of the present invention is shown. The optical disc drive shown in FIG. 6 detects the first and second minimum deflection acceleration points P0 and P1 during the disk 301 one rotation cycle as shown in FIG. 3 and performs a focus pull-in and/or a layer jump using the phase values P0′ and P1′ of the detected first and second minimum deflection acceleration points P0 and P1.

As shown in FIG. 6, the optical disc drive includes a disc 601, a pickup portion 610, an RF amplification portion 615, a servo digital signal processor (hereinafter, referred to as “servo DSP (digital signal processor)”) 620, a spindle driver 630, a spindle motor 635, a focus driver 640, a focus actuator 645, and a control module 650. The disc 601, the pickup portion 610, the RF amplification portion 615, the spindle driver 630, the spindle motor 635, the focus driver 640, the focus actuator 645, and the control module 650 shown in FIG. 6 are configured and operated in a similar manner as that of the disc 301, the pickup portion 310, the RF amplification portion 315, the spindle driver 330, the spindle motor 335, the focus driver 340, the focus actuator 345, and the control module 350 shown in FIG. 3.

The servo DSP 620, like the servo DSP 320 of FIG. 3, detects the first minimum deflection acceleration point P0 having the (+) maximum deflection size of the data layer of the disc 601 and the second minimum deflection acceleration point P1 having the (−) maximum deflection size of the data layer of the disc 601 and performs a focus pull-in and/or a layer jump using the phase value P0′ of the detected first minimum deflection acceleration point P0 and the phase value P1′ of the detected second minimum deflection acceleration point P1.

That is, when the rotation of the disc 601 is recognized to start based on a frequency generation signal provided by the spindle driver 630, the servo DSP 620 calculates the amount of change of the focus actuator drive signal. When the phase P0′ corresponding to the first minimum deflection acceleration point P0 after the one rotation of the disc 601 starts is detected, the servo DSP 620 generates a focus actuator drive signal according to the amount of change of the focus actuator drive signal. Then, when a point that satisfies the focus pull-in condition is detected, the servo DSP 620 performs focus pull-in with respect to the data layer of the disc 601.

For the upward focus pull-in, when the objective lens 611 is moved upward by the focus actuator 645 at the phase of P0′ or P1′ from the disc one rotation start position and a signal satisfying the data layer detection condition of the disc 601 at the positions P1′ and P0′, where a 180° phase delay is generated, is detected, the positions P1′ and P0′ where the 180° phase delay is generated are determined as points that satisfy the focus pull-in condition.

To operate as described above, the servo DSP 620 includes an ADC 621, a servo error signal detection portion 622, a control portion 623, a switch 624, a DAC 625, a phase detection portion 626, and a focus servo control portion 627. The ADC 621, the servo error signal detection portion 622, the DAC 625, and the phase detection portion 626 are configure and operated similar to the ADC 321, the servo error signal detection portion 322, the DAC 324, and the phase detection portion 325 shown in FIG. 3.

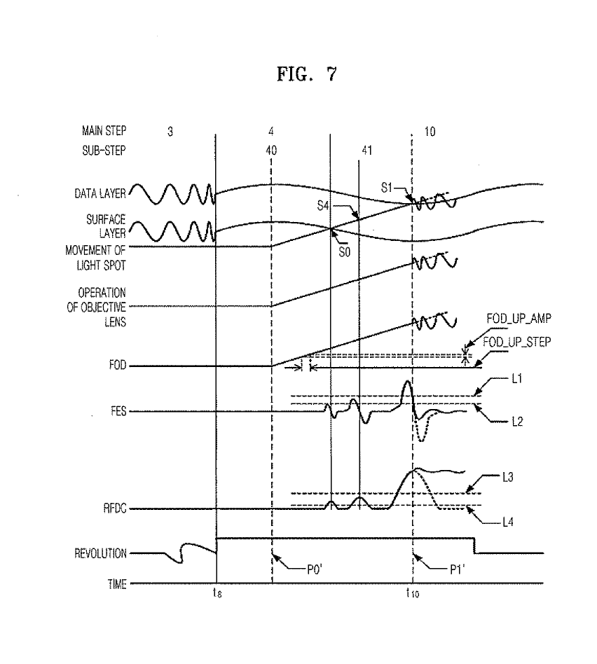

FIG. 7 is an operation timing diagram of the upward focus pull-in around the minimum deflection acceleration point having the (−) maximum deflection size in the optical disc drive shown in FIG. 6. The focus pull-in operation of FIG. 6 will be described below with reference to FIG. 7.

First, when the disc one rotation cycle start point is recognized by the frequency generation signal FG provided by the spindle driver 630, the control portion 623 calculates the amount of change of the FOD using the rotation cycle of the disc 601 and the thickness of the disc (a time until the surface layer and data layer detection). Next, the control portion 623 maintains a standby state until a point corresponding to P0′ is detected based on the previously stored P0′. When the P0′ point is detected, the control portion 623 generates FOD, to which the amount of change of FOD is added. The addition of the amount of change of FOD to the FOD in the case of FIG. 7 is due to the fact that FIG. 7 illustrates a case of an upward focus pull-in. Thus, in FIG. 7, the amount of change of FOD is defined as FOD_UP_AMP. For the downward focus pull-in case, the control portion 623 generates an FOD from which the amount of change of FOD is subtracted. At this time, the amount of change of the FOD can be defined by FOD_DOWN_AMP.

The control portion 623 checks whether a point that satisfies the focus pull-in condition is detected based on the result of detection of the surface layer and data layer with respect to the disc 601 provided by the servo error signal detection portion 622. To satisfy the focus pull-in condition, a point where an FES level is L1 or more and a point where the level of the RFDC servo error signal is L3 or more, which are detected by the servo error signal detection portion 622, match the phase P1′ of the second minimum deflection acceleration point P1. When the point satisfying the focus pull-in condition is detected, the control portion 623 turns on the focus servo control portion 627 to perform focus pull-in.

Accordingly, when the focus servo control portion 627 is off, the switch 624 outputs the FOD output from the control portion 623 through the DAC 625. When the focus servo control portion 627 is on, the switch 624 outputs the FOD output from the focus servo control portion 627 through the DAC 625.

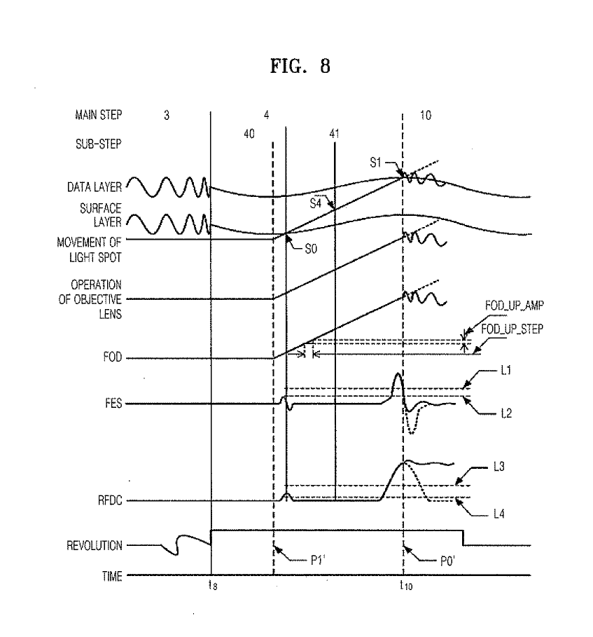

FIG. 8 is an operation timing diagram of the upward focus pull-in around the minimum deflection acceleration point having the (+) maximum deflection size in the optical disc drive shown in FIG. 6. FIG. 8 is similar to FIG. 7 except that the control portion 623 generates an FOD to which the amount of change of the FOD is added and focus pull-in is performed at the phase P0′ corresponding to the first minimum deflection acceleration point P0, to move the objective lens upward at the phase P1 corresponding to the second minimum deflection acceleration point P1.

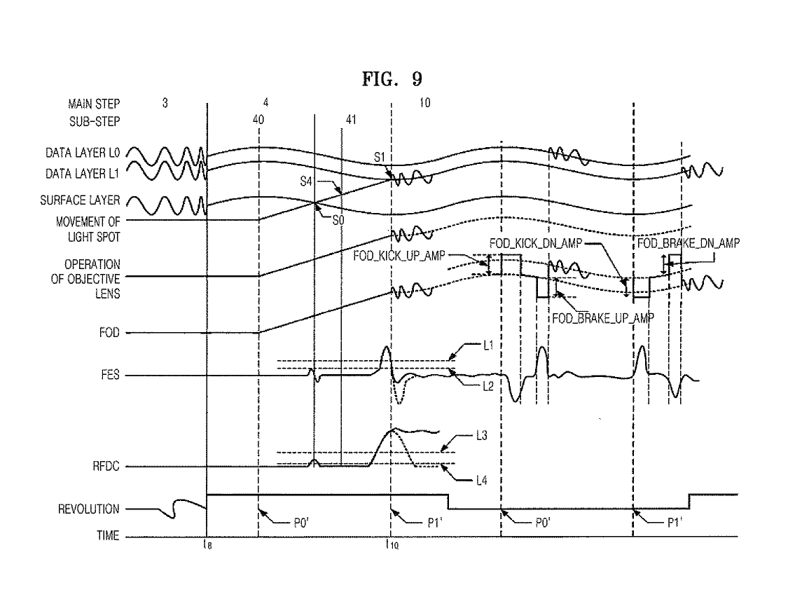

FIG. 9 is an operation timing diagram of the layer jump in the optical disc drive shown in FIG. 6. FIG. 9 shows a case in which a layer jump is required in an upward direction (from the lower layer to the upper layer) by the control module 650 after focus pull-in is performed at the phase P1′ and a layer jump is required in a downward direction (from the upper layer to the lower layer) by the control module 650 before the P1 point is detected, to explain an upward direction layer jump process and a downward direction layer jump process.

As shown in FIG. 9, when the upward direction layer jump is required by the control module 650 after focus pull-in is performed at the point P1 and the rotation of the disc starts, the control portion 623 maintains a standby state until reaching the point P0′. When the point P0′ is reached, the control portion 623 turns off the focus servo control portion 627 and generates an FOD FOD_KICK_UP_AMP by the addition of a kick pulse. Accordingly, when the servo error signal detection portion 622 detects an FES level satisfying a layer jump condition, the control portion 623 generates an FOD FOD_BRAKE_UP_AMP by the addition of a brake pulse. Accordingly, the layer jump is finished. The control portion 623 performs focus pull-in by turning on the focus servo control portion 627.

As shown in FIG. 9, when the downward direction layer jump is required before the point P1′ is detected, the control portion 623 maintains a standby state until reaching the point P1′. When the point P1′ is reached, the control portion 623 turns off the focus servo control portion 627 and generates an FOD FOD_KICK_DN_AMP by subtracting an FOD kick pulse. Accordingly, when the servo error signal detection portion 622 detects an FES level that satisfies a layer jump condition, the control portion 623 generates an FOD FOD_BRAKE_DN_AMP by subtracting a brake pulse. Thus, the layer jump is completed. The control portion 623 performs focus pull-in by turning on the focus servo control portion 627.

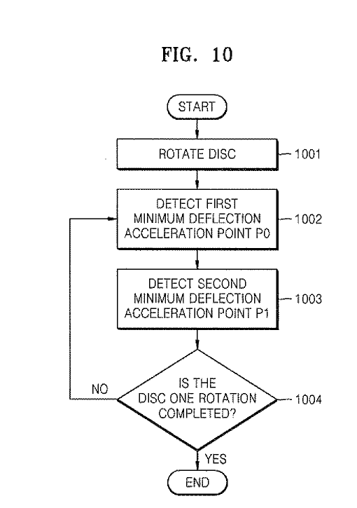

FIG. 10 is a flow chart to explain the minimum deflection acceleration point detection method according to still another example embodiment of the present invention. The operation flow chart of FIG. 10 will be described with reference to FIG. 3. That is, as the spindle driver 330 and the spindle motor 335 are driven by the servo DSP 320, the disc 301 is rotated (S1001). The rotation of the disc 301 can be included in a dynamic DDT process. This means that the minimum deflection acceleration point can be detected in the DDT process.

Next, the servo DSP 320 detects the first minimum deflection acceleration point of the disc 301 during the one rotation cycle of the disc 301 (S1002). When the first minimum deflection acceleration point is the point P0 having the (+) maximum deflection size of the data layer of the disc 301 as shown in FIG. 4, the servo DSP 320 detects the first minimum deflection acceleration point based on the symmetry of the surface layer and the data layer of the disc 301 or the symmetry of the focus actuator drive signal when the objective lens 311 moves upward and then downward. The determination of the symmetry of the surface layer and the data layer of the disc 301 and the determination of the symmetry of the focus actuator drive signal are performed as described in FIG. 4.

The servo DSP 320 detects the second minimum deflection acceleration point of the disc 302 during the one rotation cycle of the disc 301 (S1003). When the second minimum deflection acceleration point is the point P1 having the (−) maximum deflection size of the data layer of the disc 301 as shown in FIG. 4, the servo DSP 320 detects the second minimum deflection acceleration point based on the symmetry of the surface layer and the data layer of the disc 301 or the symmetry of the focus actuator drive signal when the objective lens 311 moves downward and then upward. When the one rotation of the disc 301 is complete, the servo DSP 320 completes the minimum deflection acceleration point detection work.

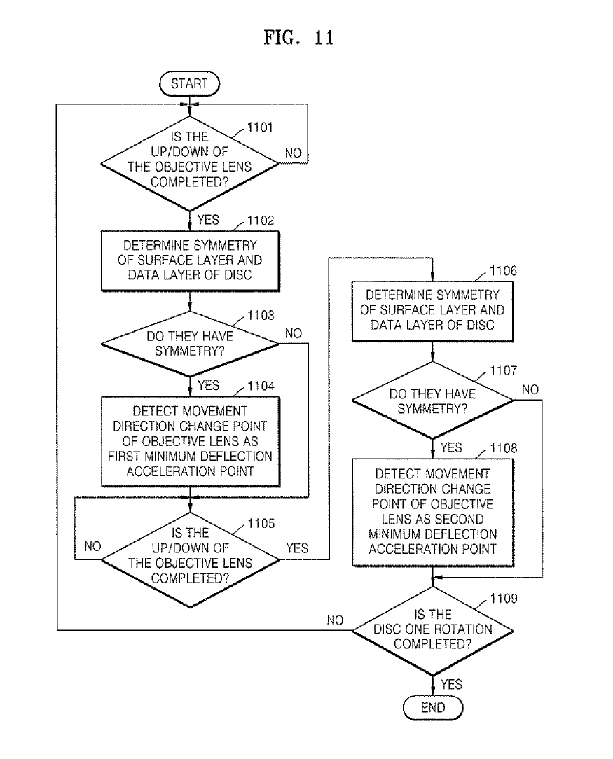

FIG. 11 is a detailed flow chart of an example of the minimum deflection acceleration point detection process shown in FIG. 10 based on the symmetry of the surface layer and data layer of a disc. The operation flow chart of FIG. 11 will be described below with reference to FIG. 3.

First, the servo DSP 320 checks whether the up/down movement of the objective lens 311 is completed (S1101). The up/down movement of the objective lens 311 means that information on the position of the surface layer and data layer of the disc 301 according to the movement direction of the objective lens 311 is detected and information to determine the symmetry based on the phase at which the change of direction of the objective lens 311 is made is collected.

When the up/down of the objective lens 311 is complete, the servo DSP 320 determines the symmetry of the surface layer and data layer of the disc 301 based on the phase at which the change in the up/down direction of the objective lens is made (S1102). The determination of symmetry can be performed as shown in FIG. 4.

That is, the servo DSP 320 determines the symmetry using at least one of a first symmetry determination process using the time T_UP0 from the surface layer detection to the data layer detection during the upward movement of the objective lens 311 and the time T_DN0 from the data layer detection to the surface layer detection during the downward movement of the objective lens 311, a second symmetry determination process using the time T_UP1 from the data layer detection to the movement direction change during the upward movement of the objective lens 311 and the time T_DN1 from the movement direction change to the data layer detection during the downward movement of the objective lens 311, and a third symmetry determination process using the time T_UP2 from the surface layer detection to the movement direction change during the upward movement of the objective lens 311 and the time T_DN2 from the movement direction change to the surface layer detection during the downward movement of the objective lens 311. The symmetry determination can be performed using a critical value based on a predetermined error range as in Equation 1.

When the surface layer and data layer of the disc 301 is determined to have symmetry based on the phase at which the direction change of the objective lens 311 is made (S1103), the servo DSP 320 detects the point at which the movement direction of the objective lens 311 changes as being the first minimum deflection acceleration point P0 (S1104).

Next, the servo DSP 320 checks whether the down/up of the objective lens 311 is completed (S1105). The up/down of the objective lens 311 means that, when the objective lens 311 starts downward movement and completes upward movement, information on the position of the surface layer and data layer of the disc 301 according to the movement direction of the objective lens 311 is detected and information for determining the symmetry based on the phase at which the change of direction of the objective lens 311 is made are collected.

When the up/down of the objective lens 311 is completed, the servo DSP 320 determines the symmetry of the surface layer and data layer of the disc 301 based on the phase at which the change in the up/down direction of the objective lens 311 is made (S1106). The determination of symmetry can be performed as shown in FIG. 4. That is, the determination of symmetry can be performed using a critical value based on a predetermined error range as in Equation 2.

When the surface layer and data layer of the disc 301 are determined to have symmetry based on the phase at which the direction change of the objective lens 311 is made in S1107, the servo DSP 320 detects the point at which the movement direction of the objective lens 311 changes as being the second minimum deflection acceleration point P1 (S1108). When the one rotation of the disc 301 is completed, the servo DSP 320 completes the minimum deflection acceleration point detection work (S1109). However, when the one rotation of the disc 301 is not completed, the program returns to S1101 and the above-described processes are repeatedly performed. Also, when the surface layer and data layer of the disc 301 is determined not to have symmetry based on the phase at which the direction change of the objective lens 311 is made, as a result of checking in S1105, the phase at which the movement direction change of the objective lens 311 is made in the up/down section of the objective lens 311 in S1101 is not the minimum deflection acceleration point. Thus, the servo DSP 320 does not detect the phase at which the movement direction change of the objective lens 311 in the up/down section of the objective lens 311 is made, as the minimum deflection acceleration point and the program proceeds to S1105.

When the surface layer and data layer of the disc 301 is determined not to have symmetry based on the phase at which the movement direction change of the objective lens 311 is made in S1107, the phase at which the movement direction change of the objective lens 311 is made in the up/down section of the objective lens 311 in S1105 is not the minimum deflection acceleration point. Thus, the program proceeds from S1107 to S1109 such that the servo DSP 320 does not detect the phase at which movement direction change of the objective lens 311 is made in the up/down section of the objective lens 311 in S1105 as the minimum deflection acceleration point.

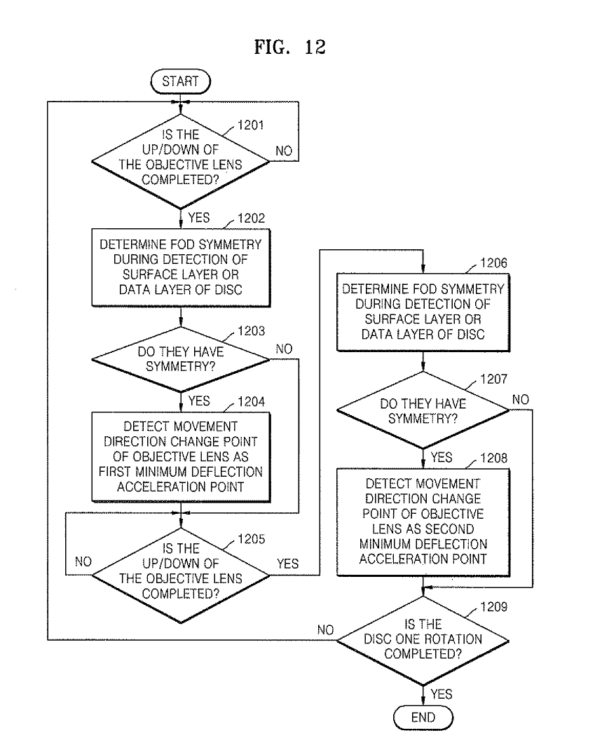

FIG. 12 is a detailed flow chart of another example embodiment of the minimum deflection acceleration point detection process shown in FIG. 10, in which the minimum deflection acceleration point is detected using the symmetry of the focus actuator drive signal FOD.

First, the servo DSP 320 checks whether the up/down of the objective lens 311 is completed (S1201). The up/down of the objective lens 311 means that, when the objective lens 311 starts upward movement and completes downward movement, information on the position of the surface layer and data layer of the disc 301 according to the movement direction of the objective lens 311 is detected and information to allow for a determination of whether the symmetry based on the phase at which the change of direction of the objective lens 311 is made is collected.

When the up/down of the objective lens 311 is completed, the servo DSP 320 determines the symmetry of the focus actuator drive signal FOD during the detection of the surface layer or data layer of the disc 301 based on the phase at which the direction change of the objective lens 311 is made (S1202).

The determination of symmetry can be performed as shown in FIG. 4. That is, the servo DSP 320 determines the symmetry using at least one of a first symmetry determination process using the focus actuator drive signal in the surface layer detection of the disc 301 during the upward movement of the objective lens 311 and the focus actuator drive signal in the surface layer detection of the disc 301 during the downward movement of the objective lens 311, and a second symmetry determination process using the focus actuator drive signal in the data layer detection of the disc 301 during the upward movement of the objective lens 311 and the focus actuator drive signal in the data layer detection of the disc 301 during the downward movement of the objective lens 311.

When the focus actuator detected from the surface layer or data layer of the disc 301 based on the phase at which the direction change of the objective lens 311 is made, is determined to have symmetry (S1203), the servo DSP 320 detects the movement direction change point of the objective lens 311 as the first minimum deflection acceleration point P0 (S1204).

Next, the servo DSP 320 checks whether the down/up of the objective lens 311 is completed (S1205). The up/down of the objective lens 311 means that, when the objective lens 311 starts downward movement and completes upward movement, information on the position of the surface layer and data layer of the disc 301 according to the movement direction of the objective lens 311 is detected and information to allow for a determination of whether the symmetry based on the phase at which the change of direction of the objective lens 311 is made, are collected.

When the up/down of the objective lens 311 is completed, the servo DSP 320 determines the symmetry of the focus actuator drive signal during the detection of the surface layer or data layer of the disc 301 based on the phase at which the change in the up/down direction of the objective lens 311 is made (S1206). The determination of symmetry can be performed as shown in FIG. 4.

When the focus actuator drive signal during the detection of the surface layer or data layer of the disc 301 is determined to have symmetry based on the phase at which the direction change of the objective lens 311 is made in S1207, the servo DSP 320 detects the movement direction change point of the objective lens 311 as the second minimum deflection acceleration point P1 (S1208). When the one rotation of the disc 301 is completed, the servo DSP 320 completes the minimum deflection acceleration point detection work (S1209). However, when the one rotation of the disc 301 is not completed, the program returns to S1201 and the above-described processes are repeatedly performed. Also, when the focus actuator drive signal during the detection of the surface layer or data layer of the disc 301 is determined not to have symmetry as a result of checking in S1203, the phase at which the movement direction change of the objective lens 311 is made in the up/down section of the objective lens 311 in S1201 is not the minimum deflection acceleration point. Thus, the servo DSP 320 does not detect the phase as the minimum deflection acceleration point and the program proceeds to S1205.

When the focus actuator drive signal during the surface layer or data layer of the disc 301 is determined in S1207 not to have symmetry based on the phase at which the movement direction change of the objective lens 311 is made, the phase at which the movement direction change of the objective lens 311 is made in the up/down section of the objective lens 311 in S1205 is not the minimum deflection acceleration point. Thus, the servo DSP 320 does not detect the phase as the minimum deflection acceleration point and the program proceeds to S1209.

The minimum deflection acceleration point may not be detected at all or one or two or more minimum deflection acceleration point can be detected during the disc one rotation cycle according to FIG. 11 or 12. When no minimum deflection acceleration point or one minimum deflection acceleration point is detected during the disk one rotation cycle, the example embodiments of the minimum deflection acceleration point detection processes of FIG. 11 or 12 can be modified such that the minimum deflection acceleration point detection process defined in FIG. 11 or 12 is performed again after an error range, for example, a critical value, is adjusted in the symmetry determination.

That is, the minimum deflection acceleration point detection processes of FIG. 11 or 12 can be modified to include determining whether the number of the minimum deflection acceleration point detected after the determining whether the one rotation of the disc shown in FIG. 11 or 12 is completed is not more than 1, a return to the first operation after adjusting the error range used for the symmetry determination when the number of the detected minimum deflection acceleration point is not more than 1, and a completion of the minimum deflection acceleration point detection work when the number of the detected minimum deflection acceleration point is more than 1.

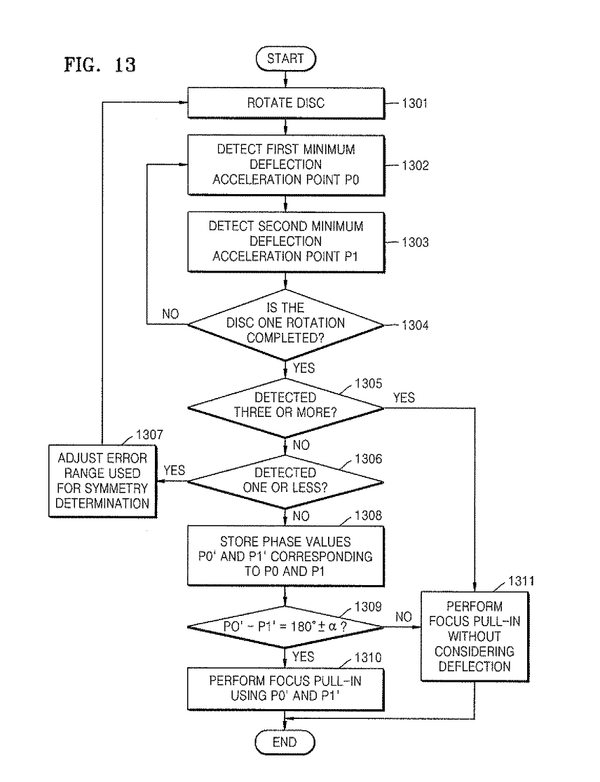

FIG. 13 is an operation flow chart of the focus pull-in method according to yet another embodiment of the present invention. The operation of FIG. 13 will be described with reference to FIG. 6.

First, the operations S1301 through S1303 of FIG. 13 are similar to the operations 1001 through 1004 of FIG. 10. Thus, when the first minimum deflection acceleration point P0 and the second minimum deflection acceleration point P1 are detected during the disc one rotation cycle, the servo DSP 620 checks whether the number of the detected minimum deflection acceleration points is three or more (S1305). As a result of the checking, when the number of the detected minimum deflection acceleration points is not three or more, the servo DSP 620 checks whether the number of the detected minimum deflection acceleration points is one or less (S1306). As a result of the checking, when the number of the detected minimum deflection acceleration points is one or less, the error range used for the determination of symmetry, for example, the critical values DIFF_UPDOWN0, DIFF_UPDOWN1, and DIFF_UPDOWN2 in Equations 1 and 2, is adjusted (S1307). That is, the error range can be adjusted to make the critical values DIFF_UPDOWN0, DIFF_UPDOWN1, and DIFF_UPDOWN2 greater values. Next, the program returns to S1301 and the servo DSP 620 performs the process of detecting the minimum deflection acceleration point.

However, as a result of the checking in S1306, when the number of the detected minimum deflection acceleration point is not one or less, the servo DSP 620 stores the phase value P0′ corresponding to the first minimum deflection acceleration point P0 detected in S1302 and the phase value P1′ corresponding to the second minimum deflection acceleration point P1′ detected in S1303 (S1308).

The servo DSP 620 checks whether the phase difference between the stored P0′ and P1′ is 180°±α (S1309). The constant, α, is a margin phase. As a result of the checking, when the phase difference between the P0′ and P1′ is 180°±α, the servo DSP 620 performs focus pull-in using the stored P0′ and P1′ (S1310).

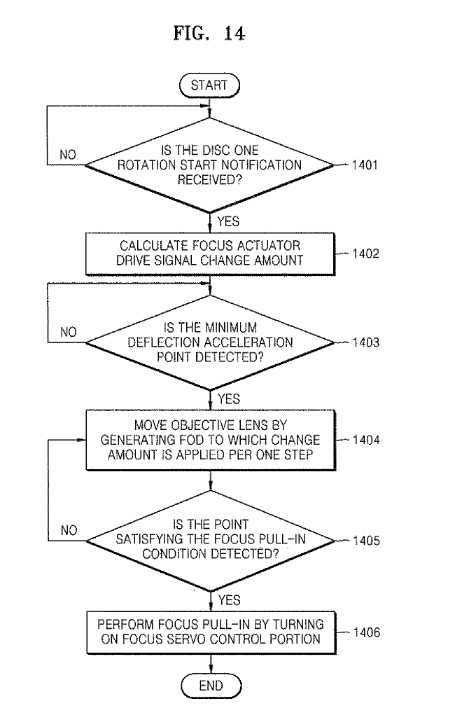

The focus pull-in in S1310 is performed as shown in FIG. 14. FIG. 14 is a detailed flow chart of the focus pull-in process shown in FIG. 13. Referring to FIG. 14, when the one rotation start of the disc 601 is notified, the servo DSP 620 calculates the amount of change of the focus actuator drive signal (S1401 and S1402). The amount of change of the focus actuator drive signal can be calculated as described in FIGS. 6 and 7.

After the one rotation start of the disc 601, when the first minimum deflection acceleration point is detected (S1403), the servo DSP 620 generates the focus actuator drive signal by an application of the amount of change of the focus actuator drive signal and moves the objective lens 611 (S1404). That is, when the focus pull-in is an upward focus pull-in, the focus actuator drive signal to which the amount of change of the focus actuator drive signal is added is generated to move the objective lens 611. When the focus pull-in is a downward focus pull-in, the focus actuator drive signal from which the amount of change of the focus actuator drive signal is subtracted is generated to move the objective lens 611.

Accordingly, when a point satisfying the focus pull-in condition is detected (S1405), the servo DSP 620 turns on the focus servo control portion 627 to perform the focus pull-in with respect to the disc 601. Here, the focus pull-in condition is similar to that described in FIGS. 6 and 7.

As a result of the checking in S1305 of FIG. 13, when the number of the detected minimum deflection acceleration points is three or more or the phase difference between the P0′ and P1′ is not 180 or 180°±α in S1309, since the deflection of the disc 601 is small, the servo DSP 620 performs focus pull-in without considering the deflection (S1311).

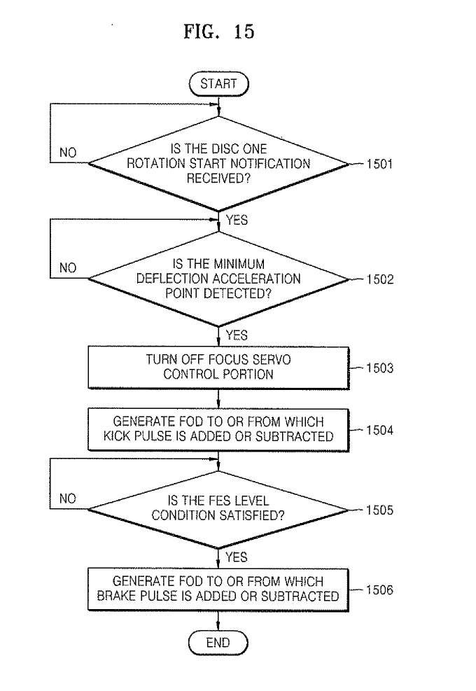

FIG. 15 is an operation flow chart of a layer jump method according to yet another embodiment of the present invention. The method of FIG. 15 can be performed after the focus pull-in of FIG. 13. The operation of FIG. 15 will be described below with reference to FIG. 6.

After a layer jump is found to be required, when the one rotation start of the disc 601 is notified and the first minimum deflection acceleration point is detected, the servo DSP 620 turns off the focus servo control portion 627 (S1501, S1502, and S1503). The first minimum deflection acceleration point can be one of the first minimum deflection acceleration point having the (+) maximum deflection size of the data layer of the disc 601 and the second minimum deflection acceleration point having the (−) maximum deflection size of the data layer of the disc 601 according to the point when the layer jump is required.

Next, the servo DSP 620 generates the focus actuator drive signal to or from which a kick pulse is added or subtracted according to the layer jump direction as described in FIG. 9 (S1504). When the level of the focus error signal generated accordingly satisfies the layer jump condition (S1505), the servo DSP 620 generates the focus actuator drive signal to or from which a brake pulse is added or subtracted according to the layer jump direction so that the layer jump is completed (S1506). FIG. 15 can be modified such that the layer jump requirement can be input after the disc one rotation start notification is received.

The program to perform the minimum deflection acceleration point detection, focus pull-in, and layer jump methods according to the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As is described above, aspects of the present invention can enable a stable focus pull-in and minimize the collision between the disc and the objective lens during the focus pull-in by performing the focus pull-in at the minimum deflection acceleration point of the disc loaded in a high density or low density optical information storing and reproducing apparatus.

Also, aspects of the present invention can enable a stable layer jump and minimize the collision between the disc and the objective lens during the layer jump by performing the layer jump at the minimum deflection acceleration point of the disc loaded in a high density or low density optical information storing and reproducing apparatus.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. Accordingly, it is intended, therefore, that the present invention not be limited to the various example embodiments disclosed, but that the present invention includes all embodiments falling within the scope of the appended claims.

What is claimed is:

1. A method of detecting a minimum deflection acceleration point in an optical disc drive, the method comprising:
rotating a disc loaded in the optical disc drive;
detecting a first minimum deflection acceleration point of the disc during one rotation cycle of the disc; and
detecting a second minimum deflection acceleration point of the disc during one rotation cycle of the disc.

2. The method according to claim 1, wherein the first minimum deflection acceleration point is detected using a symmetry of a surface layer and a data layer of the disc based on a phase at which the movement direction of an objective lens provided in the optical disc drive changes when the objective lens moves upward and then downward.

3. The method according to claim 2, wherein the second minimum deflection acceleration point is detected using a symmetry of the surface layer and the data layer of the disc based on the phase at which the movement direction of the objective lens changes when the objective lens moves downward and then upward.

4. The method according to claim 3, wherein the symmetries are determined using at least one of a first symmetry determination process using a time from the detection of the surface layer to the detection of the data layer during the upward movement of the objective lens and a time from the data layer detection to the surface layer detection during the downward movement of the objective lens, a second symmetry determination process using a time from the data layer detection to the change of the movement direction during the upward movement of the objective lens and a time from the movement direction change to the data layer detection during the downward movement of the objective lens, and a third symmetry determination process using a time from the surface layer detection to the movement direction change during the upward movement of the objective lens and a time from the movement direction change to the surface layer detection during the downward movement of the objective lens.

5. The method according to claim 4, wherein the determination of the symmetry is performed using a critical value based on a predetermined error range.

6. The method according to claim 1, wherein the first and second minimum deflection acceleration points are detected using a symmetry of a focus actuator drive signal (FOD) of the optical disc drive.

7. The method according to claim 6, wherein the symmetries are determined using at least one of a first symmetry determination process using a focus actuator drive signal in the detection of the surface layer of the disc during the upward movement of an objective lens provided in the optical disc drive and a focus actuator drive signal in the detection of the surface layer of the disc during the downward movement of the objective lens, and a second symmetry determination process using a focus actuator drive signal in the data layer detection of the disc during the upward movement of the objective lens and a focus actuator drive signal in the data layer detection of the disc during the downward movement of the objective lens.

8. The method according to claim 1 wherein the first and second minimum deflection acceleration points are detected during a disc type detection process.

9. A focus pull-in method for use in an optical disc drive, the method comprising:
calculating an amount of a change of a focus actuator drive signal when a start of a single rotation cycle of a disc loaded in the optical disc drive is notified;
generating a focus actuator drive signal according to the amount of the change of the focus actuator drive signal when a first minimum deflection acceleration point is detected after the start of the rotation of the disc; and
performing focus pull-in with respect to the disc when a point that satisfies a focus pull-in condition is detected.

10. The method according to claim 9, wherein the first minimum deflection acceleration point is detected using a symmetry of a surface layer and a data layer of the disc based on a phase at which the movement direction of an objective lens provided in the optical disc drive changes when the objective lens moves upward and then downward.

11. The method according to claim 9, when the focus pull-in is an upward focus pull-in, wherein the generating the focus actuator drive signal generates a focus actuator drive signal to which an amount of change of the focus actuator drive signal is added.

12. The method according to claim 9, wherein, when the focus pull-in is a downward focus pull-in, the generating the focus actuator drive signal generates a focus actuator drive signal from which an amount of change of the focus actuator drive signal is subtracted.

13. The method according to claim 9, wherein the amount of change of the focus actuator drive signal is calculated using a time corresponding to a length of time required to complete the rotation of the disc and a thickness of the disc.

14. The method according to claim 9, wherein the point satisfying the focus pull-in condition is a point where a level of a focus error signal (FES) and a level of an RFDC servo error signal satisfy a data layer detection condition of the disc at a point where the second minimum defection acceleration point is detected after the start of the rotation of the disc.

15. A layer jump method for use in an optical disc drive, the method comprising:
turning off a focus servo control portion of the optical disc drive when a first minimum deflection acceleration point is detected after a layer jump is found to be required;
generating a focus actuator drive signal to or from which a kick pulse is added or subtracted according to a direction of the layer jump; and
generating a focus actuator drive signal to or from which a brake pulse is added or subtracted according to the direction of the layer jump when a level of a focus error signal satisfies a layer jump condition.

16. The method according to claim 15, wherein the first minimum deflection acceleration point is detected using a symmetry of a surface layer and a data layer of an optical disc based on a phase at which the movement direction of an objective lens provided in the optical disc drive changes when the objective lens moves upward and then downward.

17. The method according to claim 15, wherein the method is performed while rotating the disc loaded in the optical disc drive.

18. The method according to claim 15, wherein the first minimum deflection acceleration point is one of a first minimum deflection acceleration point having a (+) maximum deflection size of a data layer of the disc and a second minimum deflection acceleration point having a (−) maximum deflection size of the data layer of the disc according to a point when the layer jump is required.

19. A computer readable medium having programs stored thereon to execute the method according to claim 16.

20. An optical disc drive comprising:
a disc loaded in the optical disc drive;
a rotation unit to rotate the disc; and
a servo digital signal processor to detect a first minimum deflection acceleration point and a second minimum deflection acceleration point during a rotation cycle of the disc and to generate a focus actuator drive signal according the detection of the acceleration points.

21. The optical disc drive according to claim 20, wherein the first minimum deflection acceleration point is detected using a symmetry of a surface layer and a data layer of the disc based on a phase at which the movement direction of an objective lens provided in the optical disc drive changes when the objective lens moves upward and then downward.

22. The optical disc drive according to claim 20, wherein the first minimum deflection acceleration point is a point having a (+) maximum deflection size of the data layer of the disc and the second minimum deflection acceleration point is a point having a (−) maximum deflection size of the data layer of the disc.

23. The optical disc drive according to claim 22, wherein, when the rotation start of the disc is recognized based on a frequency generation signal provided by the rotation unit, the servo digital signal processor calculates an amount of a change of a focus actuator drive signal, generates a focus actuator drive signal according to the amount of change of the focus actuator drive signal when the first minimum deflection acceleration point is detected after the start of the rotation, and controls focus pull-in with respect to the disc when a point satisfying a focus pull-in condition is detected.

24. The optical disc drive according to claim 23, wherein the point that satisfies the focus pull-in condition is a: point where a level of a focus error signal (FES) and a level of an RFDC servo error signal satisfy a data layer detection condition of the disc at a point where the second minimum defection acceleration point is detected after the start of the rotation of the disc.

25. The optical disc drive according to claim 20, wherein, when the layer jump is required, the servo digital signal processor turns off a focus servo control operation when the first minimum deflection acceleration point is detected after the layer jump is found to be required, generates a focus actuator drive signal to or from which a kick pulse is added or subtracted according to a layer jump direction, and generates a focus actuator drive signal to or from which a brake pulse is added or subtracted according to a layer jump direction when a level of a focus error signal satisfies a layer jump condition.

26. The optical disc drive according to claim 22, wherein the first minimum deflection acceleration point is one of the first minimum deflection acceleration point and the second minimum deflection acceleration point according to a time point where the layer jump is required.

27. A method of operating an optical disc drive based on a detection of a minimum deflection acceleration point of an optical disc loaded in the optical disc drive, the method comprising:
causing the optical disc to rotate;
detecting first and second minimum deflection acceleration points of the optical disc during one rotation cycle of the disc; and
generating a servo control signal based on respective differences between the first and second minimum deflection acceleration points and preset first and second minimum deflection acceleration points to control a position and an orientation of an objective lens for recording/reproducing information to and/or from the optical disc.

28. The method according to claim 27, wherein the first minimum deflection acceleration point is detected using a symmetry of a surface layer and a data layer of the disc based on a phase at which the movement direction of an objective lens provided in the optical disc drive changes when the objective lens moves upward and then downward.
